(19) United States
(12) Patent Application Publication
(10) Pub. No.: US 2005/0023027 A1
(43) Pub. Date: Feb. 3, 2005

(54) Illuminating bus cable

(76) Inventor: Jen Chien Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/631,818

(22) Filed: Aug. 1, 2003

(51) Int. Cl. H01B 7/36

(52) U.S. Cl. 174/112

(57) ABSTRACT

An illuminating cable assembly for connection between a host computer and a peripheral device includes a length of cable comprising a plurality of elongate conductive members having opposite ends. First and second plugs are connected to opposite ends of the cable. At least one of the first and second plugs includes a casing made of light-transmitting material and mounted to an end of the cable with the end of the elongate conductive member extending into the casing, a contact member mounted to the casing and electrically connected to the elongate conductive member, and an illuminating element electrically connected to the contact member by a resistor. When a signal travels through the cable, the illuminating device gives off light that transmits through the light-transmitting casing for providing a visual indication to an operator.

### BACKGROUND OF THE INVENTION

1. Field of the Invention

The present invention generally relates to a bus cable for connecting a host computer and a peripheral device, and in particular to an illuminating bus cable which selectively gives off light for indication of operation condition.

2. The Related Art

A host computer is connected by a signal line to a peripheral device for transmission of signals and power therebetween. Such signal lines are commonly formed by a cable having opposite ends connected to the host computer and the peripheral device, respectively. The end of the cable is secured to the host computer by means of for example bolts or resilient snap-on fasteners. Thus, connection of the cable to the host computer is troublesome to a computer user. Further, poor electrical connection between the cable and the computer cannot be observed visually.

The currently prevailing USB (Universal Serial Bus) cable provides a measure for data transmission of high speed and easy mating between the cable and the computer. Still, the USB cable has no means to indicate poor electrical connection between the cable and the computer and the computer user has in general no easy to inspect such a poor connection by vision.

Thus, it desired to have a computer signal cable that overcomes the above deficiency.

### SUMMARY OF THE INVENTION

An object of the present invention is to provide an illuminating cable that selectively gives off light for indication of electrical connection between a host computer and the cable.

Another object of the present invention is to provide a cable for connection between a host computer and a peripheral device wherein the cable is capable of giving off light to the indication electrical connection between the host computer and the peripheral device.

To achieve the above objects, in accordance with the present invention, there is provided an illuminating cable assembly for connection between a host computer and a peripheral device comprising a length of cable comprising a plurality of elongate conductive members having opposite ends. First and second plugs are connected to opposite ends of the cable. At least one of the first and second plugs includes a casing made of light-transmitting material and mounted to an end of the cable with the end of the elongate conductive member extending into the casing, a contact member mounted to the casing and electrically connected to the elongate conductive member, and an illuminating element electrically connected to the contact member by a resistor. When a signal travels through the cable, the illuminating device gives off light that transmits through the light-transmitting casing for providing a visual indication to an operator.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an illuminating cable assembly constructed in accordance with the present invention;

FIG. 2 is a cross-sectional view of a first plug of the cable assembly of the present invention; and

FIG. 3 is a cross-sectional view of a second plug of the cable assembly of the present invention.

### DETAILED DESCRIPTION OF THE PREFERRED EMBODIMENTS

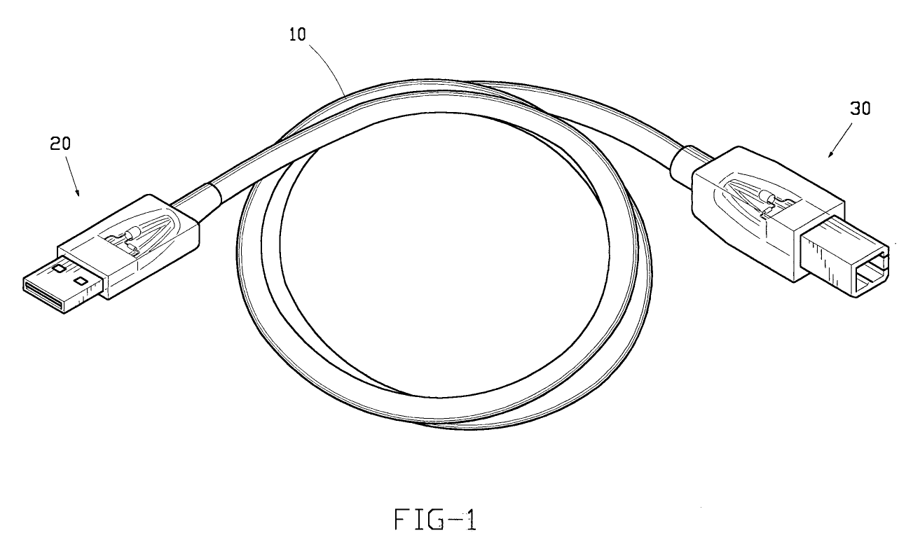

With reference to the drawings and in particular to FIG. 1, an illuminating cable assembly in accordance with the present invention comprises a length of cable 10 having opposite ends to which first and second plugs 20, 30 are mounted respectively.

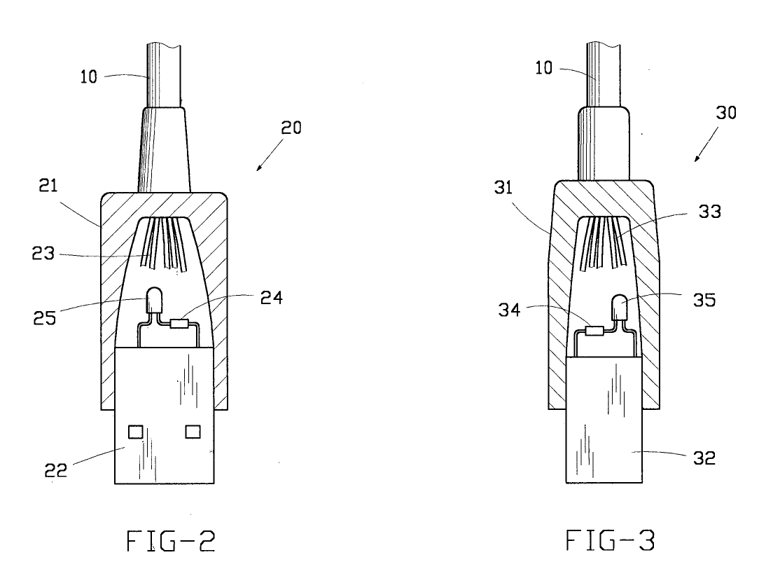

Also referring to FIG. 2, the first end plug 20 comprises a casing 21 made of light-transmitting material, such as clear plastics, and having opposite end faces of which one is connected to the end of the cable 10 and the other one receives and retains contact means 22 having an end extending out of the casing 21 for engaging a counterpart member in a host computer (not shown). The cable 10 is comprised of a number of elongate conductive members having ends 23 extending into the casing 21 and electrically connected to the contact member 22. However, the ends 23 of the elongate conductive members are separated from the contact member 22 for clear illustration purposes. A resistor 24 for voltage drop and an illuminating element 25, such as a light emitting diode (LED), are electrically connected to the contact member 22 in serial.

Also referring to FIG. 3, the second end plug 30 is different from the first end plug 20 in external specification, such as dimensions and shape, but has a similar internal construction, comprising a casing 31 made of light-transmitting material, such as clear plastics, and having opposite end faces of which one is connected to the end of the cable 10 and the other one receives and retains contact means 32 having an end extending out of the casing 31 for engaging a counterpart member in a peripheral device (not shown). The cable 10 is comprised of a number of elongate conductive members having ends 33 extending into the casing 31 and electrically connected to the contact member 32. However, the ends 33 of the elongate conductive members are separated from the contact member 32 for clear illustration purposes. A resistor 34 for voltage drop and an illuminating element 35, such as a light emitting diode (LED), are electrically connected to the contact member 32 in serial.

When the cable assembly is connected between the host computer and the peripheral device, serving as power and signal transmission, the illuminating element 24 of the first plug 20 and/or the illuminating element 34 of the second plug 30 are lit and give off light through the light-transmitting casings 21, 31 for indication of the transmission of signal and/or power. A computer user can readily observe the light through the casings 21, 31 for inspection of the transmission of signal and power through the cable assembly.

In actual applications, the first and second plugs 20, 30 can be made in a variety of ways for fitting different electronic or computer-related devices, including computer input/output devices, such as a computer mouse, a keyboard, a printer, a joystick, a digitizer, a scanner and a vision camera. Thus, when the peripheral device is connected to the host computer by the cable assembly of the present invention, the lighting of the plugs 20, 30 indicate proper transmission of signal and/or power therebetween.

Apparently, the cable 10 can be of different length for different applications. The plugs 20, 30 can be of any desired specifications for being fit for different connection ports of different electronic devices.

Although the present invention has been described with reference to the preferred embodiment thereof, it is apparent to those skilled in the art that a variety of modifications and changes may be made without departing from the scope of the present invention which is intended to be defined by the appended claims.

1. An illuminating cable assembly adapted to connect between two electronic devices, the illuminating cable assembly comprising:
a length of cable comprising at least one elongate conductive member having opposite ends; and
first and second plugs connected to opposite ends of the cable, the first plug comprising:
a casing made of light-transmitting material and mounted to an end of the cable with the end of the elongate conductive member extending into the casing,
a contact member mounted to the casing and electrically connected to the elongate conductive member, and
an illuminating element electrically connected to the contact member by a resistor;
wherein when a signal travels through the cable, the illuminating device gives off light that transmits through the light-transmitting casing for providing a visual indication to an operator.

2. The illuminating cable assembly as claimed in claim 1, wherein the second plug is different from the first plug in external specifications.

3. The illuminating cable assembly as claimed in claim 1, wherein the second plug is connectable with a computer input/output device.
